(19) United States
(12) Patent Application Publication
(10) Pub. No.: US 2026/0368291 A1
(43) Pub. Date: Nov. 19, 2026

(54) INFORMATION PROCESSING DEVICE, PORTABLE TERMINAL, INFORMATION PROCESSING METHOD, AND STORAGE MEDIUM

(71) Applicant: NEC Corporation, Tokyo (JP)

(72) Inventors: Hirokazu HAMADA, Tokyo (JP); Kensaku SATO, Tokyo (JP); Mayumi KATO, Kanagawa (JP); Tsutomu OSODA, Kanagawa (JP); Kohei KAWANO, Kanagawa (JP)

(73) Assignees: NEC Corporation, Tokyo (JP); NEC Corporation, Tokyo (JP)

(21) Appl. No.: 19/478,371

(22) PCT Filed: Jun. 6, 2023
(86) PCT No.: PCT/JP2023/021000

§ 371 Date: Oct. 24, 2025

(51) Int. Cl. G06F 21/31

(52) U.S. Cl. CPC G06F 21/31

(57) ABSTRACT

The present invention connects to a first terminal which has a structure for attaching to an ear of a user and which acquires a reflected signal of a signal outputted inside the ear, the first terminal conveying externally acquired information to a user when worn by said user. The present invention acquires a result of an authentication performed using the reflected signal. And the present invention detects the acquisition of predetermined first information. If the result of the authentication is a successful authentication, the present invention outputs, to the first terminal, information regarding the execution of predetermined processing performed using the first information.

### TECHNICAL FIELD

The present disclosure relates to an information processing device, a portable terminal, an information processing method, and a storage medium.

### BACKGROUND ART

A user transmits and receives information such as a message to another person using an information processing device. In such a case, the user needs to unlock a lock of a screen of the information processing device and confirm the received message. PTL 1 discloses the related art.

PTL 1 discloses a technique in which a voice reproduction device includes a voice output unit including a speaker or the like and voice of utterance words is reproduced based on supplied voice data (paragraph 0063 or the like).

### CITATION LIST

### Patent Literature PTL 1: WO 2018/034169 A1

### SUMMARY OF INVENTION

### Technical Problem

By the way, as described above, there has been a demand for a technology for confirming information with higher confidentiality, when a user confirms the information using an information processing device.

An object of the present disclosure is to provide an information processing device, a portable terminal, an information processing method, and a storage medium that solve the above problems.

### Solution to Problem

According to a first aspect of the present disclosure, an information processing device includes connection means for being connected to a first terminal that has a structure for being worn on a user's ear, acquires a reflection signal of a signal output to inside of the ear, and transmits information acquired from outside to a user in a state of being worn by the user, authentication result acquisition means for acquiring a result of authentication performed using the reflection signal, detection means for detecting acquisition of predetermined first information, and execution means for outputting information regarding execution of predetermined processing executed using the first information to the first terminal, in a case where the result of the authentication is an authentication success.

According to a second aspect of the present disclosure, an information processing device includes connection means for being connected to each of a first terminal that has a structure for being worn on a user's ear and acquires a reflection signal of a signal output to inside of the ear and a second terminal that transmits information acquired from outside to a user in a state of being worn by the user, authentication result acquisition means for acquiring a result of authentication performed using the reflection signal, detection means for detecting acquisition of predetermined first information, and execution means for outputting information regarding execution of predetermined processing executed using the first information to the second terminal, in a case where the result of the authentication is an authentication success.

According to a third aspect of the present disclosure, a portable terminal includes connection means for being connected to a first terminal that has a structure for being worn on a user's ear, acquires a reflection signal of a signal output to inside of the ear, and transmits information acquired from outside to a user in a state of being worn by the user, authentication result acquisition means for acquiring a result of authentication performed using the reflection signal, detection means for detecting acquisition of predetermined first information, and execution means for outputting information regarding execution of predetermined processing executed using the first information to the first terminal, in a case where the result of the authentication is an authentication success.

According to a fourth aspect of the present disclosure, a portable terminal includes connection means for being connected to each of a first terminal that has a structure for being worn on a user's ear and acquires a reflection signal of a signal output to inside of the ear and a second terminal that transmits information acquired from outside to a user in a state of being worn by the user, authentication result acquisition means for acquiring a result of authentication performed using the reflection signal, detection means for detecting acquisition of predetermined first information, and execution means for outputting information regarding execution of predetermined processing executed using the first information to the second terminal, in a case where the result of the authentication is an authentication success.

According to a fifth aspect of the present disclosure, an information processing method includes being connected to a first terminal that has a structure for being worn on a user's ear, acquires a reflection signal of a signal output to inside of the ear, and transmits information acquired from outside to a user in a state of being worn by the user, acquiring a result of authentication performed using the reflection signal, detecting acquisition of predetermined first information, and outputting information regarding execution of predetermined processing executed using the first information to the first terminal, in a case where the result of the authentication is an authentication success.

According to the fifth aspect of the present disclosure, the information processing method includes being connected to each of a first terminal that has a structure for being worn on a user's ear and acquires a reflection signal of a signal output to inside of the ear and a second terminal that transmits information acquired from outside to a user in a state of being worn by the user, acquiring a result of authentication performed using the reflection signal, detecting acquisition of predetermined first information, and outputting information regarding execution of predetermined processing executed using the first information to the second terminal, in a case where the result of the authentication is an authentication success.

According to the fifth aspect of the present disclosure, a program causes a computer of an information processing device to function as connection means for being connected to a first terminal that has a structure for being worn on a user's ear, acquires a reflection signal of a signal output to inside of the ear, and transmits information acquired from outside to a user in a state of being worn by the user, authentication result acquisition means for acquiring a result of authentication performed using the reflection signal, detection means for detecting acquisition of predetermined first information, and execution means for outputting information regarding execution of predetermined processing executed using the first information to the first terminal, in a case where the result of the authentication is an authentication success.

According to a sixth aspect of the present disclosure, a program causes a computer of an information processing device to function as connection means for being connected to each of a first terminal that has a structure for being worn on a user's ear and acquires a reflection signal of a signal output to inside of the ear and a second terminal that transmits information acquired from outside to a user in a state of being worn by the user, authentication result acquisition means for acquiring a result of authentication performed using the reflection signal, detection means for detecting acquisition of predetermined first information, and execution means for outputting information regarding execution of predetermined processing executed using the first information to the second terminal, in a case where the result of the authentication is an authentication success.

According to a seventh aspect of the present disclosure, an information processing device includes connection means for being connected to a first terminal that acquires biometric information of a user and transmits information acquired from outside to the user in a state of being worn by the user, authentication result acquisition means for acquiring a result of authentication performed using the biometric information, detection means for detecting acquisition of predetermined first information, and execution means for outputting information regarding execution of predetermined processing executed using the first information to the first terminal, in a case where the result of the authentication is an authentication success.

According to an eighth aspect of the present disclosure, an information processing device includes connection means for being connected to each of a first terminal that acquires biometric information of a user and a second terminal that transmits information acquired from outside to the user in a state of being worn by the user, authentication result acquisition means for acquiring a result of authentication performed using the biometric information, detection means for detecting acquisition of predetermined first information, and execution means for outputting information regarding execution of predetermined processing executed using the first information to the second terminal, in a case where the result of the authentication is an authentication success.

### BRIEF DESCRIPTION OF DRAWINGS

FIG. 1 is a schematic configuration diagram of an information processing system according to one example embodiment of the present disclosure.

FIG. 2 is a functional block diagram of the information processing system according to one example embodiment of the present disclosure.

FIG. 3 is a hardware configuration diagram of a portable terminal according to one example embodiment of the present disclosure.

FIG. 4 is a functional block diagram of the portable terminal and an earphone according to one example embodiment of the present disclosure.

FIG. 5 is a first diagram illustrating a processing flow of the portable terminal according to one example embodiment of the present disclosure.

FIG. 6 is a second diagram illustrating the processing flow of the portable terminal according to one example embodiment of the present disclosure.

FIG. 7 is a functional block diagram of the information processing system according to one example embodiment of the present disclosure.

FIG. 8 is a functional block diagram of the information processing system according to one example embodiment of the present disclosure.

FIG. 9 is a functional block diagram of the information processing system according to one example embodiment of the present disclosure.

FIG. 10 is a third diagram illustrating the processing flow of the portable terminal according to one example embodiment of the present disclosure.

FIG. 11 is a functional block diagram of the information processing system according to one example embodiment of the present disclosure.

FIG. 12 is a fourth diagram illustrating the processing flow of the portable terminal according to one example embodiment of the present disclosure.

FIG. 13 is a functional block diagram of the information processing system according to one example embodiment of the present disclosure.

FIG. 14 is a fifth diagram illustrating the processing flow of the portable terminal according to one example embodiment of the present disclosure.

FIG. 15 is a functional block diagram illustrating a minimum configuration of an information processing device according to one example embodiment of the present disclosure.

FIG. 16 is a diagram illustrating a processing flow by the information processing device having the minimum configuration according to one example embodiment of the present disclosure.

### EXAMPLE EMBODIMENT

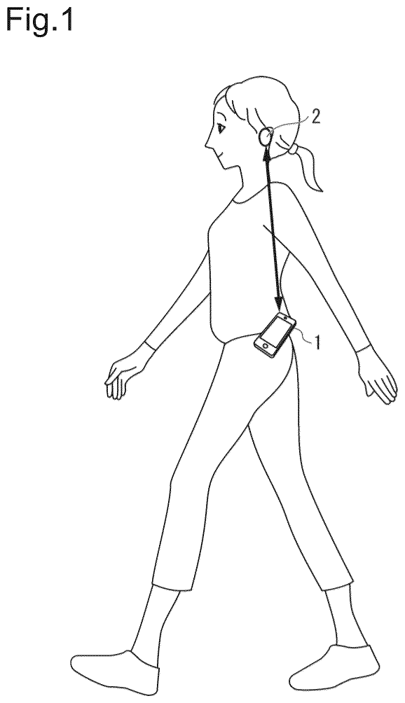

FIG. 1 is a schematic configuration diagram of an information processing system according to one example embodiment of the present disclosure.

An information processing system 100 is configured such that at least a portable terminal 1 which is one aspect of an information processing device is wirelessly communicably connected to an earphone 2 which is one aspect of a first terminal. The portable terminal 1 may be a smartphone. The earphone 2 has a structure that can be worn on a user's ear. The earphone 2 has a function for acquiring a reflection signal of a signal output to inside of the user's ear and outputting the reflection signal to the portable terminal 1. More specifically, the earphone 2 has a function for transmitting sound waves to the inside of the user's ear, acquiring a reverberation signal of the sound wave from an inner wall of the ear or the like, and outputting the reverberation signal to the portable terminal 1. The earphone 2 has a function for converting information acquired from outside into sound and transmitting the sound to the user. The portable terminal 1 performs biometric authentication using the reverberation signal as biometric information of the user.

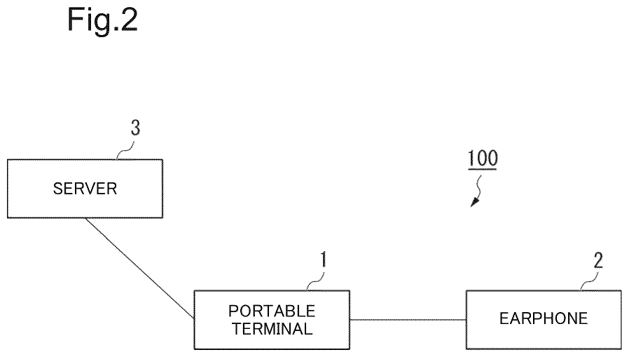

FIG. 2 is a functional block diagram of the information processing system according to one example embodiment of the present disclosure.

The information processing system 100 may include a server 3 as illustrated in FIG. 2. The server 3 outputs first information to the portable terminal 1. The portable terminal 1 outputs the first information acquired from the server 3 or second information generated by processing the first information to the earphone 2. The earphone 2 converts the first information or the second information into sound and transmits the sound to the user.

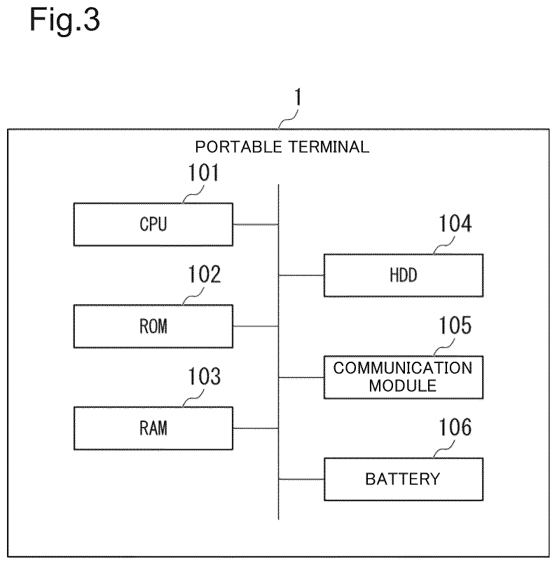

FIG. 3 is a hardware configuration diagram of a portable terminal according to one example embodiment of the present disclosure.

As illustrated in FIG. 3, the portable terminal 1 is a computer including each piece of hardware such as a Central Processing Unit (CPU) 101, a Read Only Memory (ROM) 102, a Random Access Memory (RAM) 103, a Hard Disk Drive (HDD) 104, a communication module 105, or a battery 106. The server 3 may have a similar function. The earphone 2 is a small information processing device and includes some or all of the hardware configuration of the portable terminal 1, and the hardware configuration achieves a function of the earphone 2.

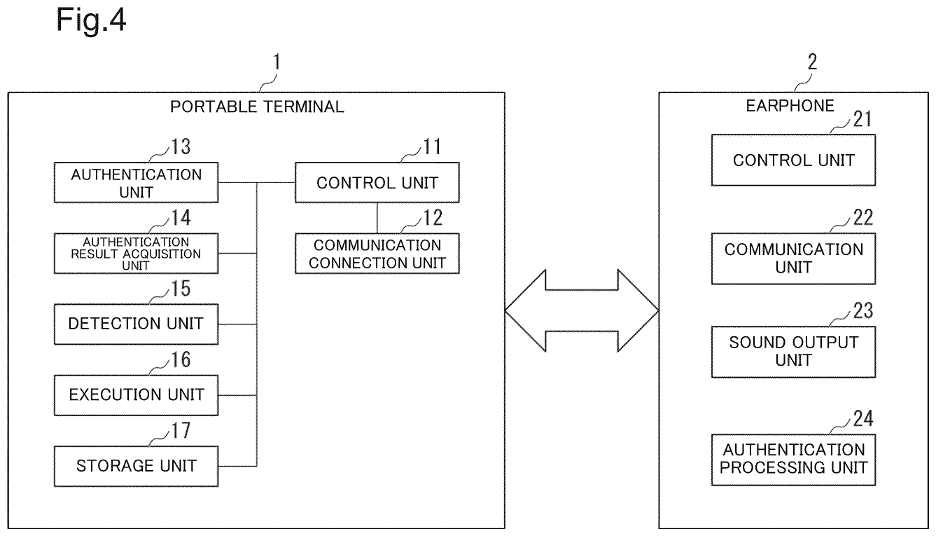

FIG. 4 is a functional block diagram of the portable terminal and the earphone according to one example embodiment of the present disclosure.

The portable terminal 1 achieves functions of each of a control unit 11, a communication connection unit 12, an authentication unit 13, an authentication result acquisition unit 14, a detection unit 15, an execution unit 16, and a storage unit 17, by execution of a program stored in advance by the CPU 101, a circuit operation, or the like.

The control unit 11 controls each functional unit of the portable terminal 1.

The communication connection unit 12 is communicably connected to the earphone 2 and transmits information to the earphone 2. The authentication unit 13 performs user authentication, based on a signal including the biometric information acquired from the earphone 2.

The detection unit 15 detects predetermined first information. The first information is, for example, information received from the server 3.

In a case where a result of authentication of a user who is wearing the earphone 2 is an authentication success, the execution unit 16 transmits information regarding execution of predetermined processing executed by using the first information to the earphone 2.

The storage unit 17 stores various types of information used by the portable terminal 1 for the processing.

The earphone 2 achieves functions of each of a control unit 21, a communication unit 22, a sound output unit 23, and an authentication processing unit 24, by execution of a program stored in advance, a circuit operation, or the like.

The control unit 21 controls each function of the earphone 2.

The communication unit 22 is connected to and communicates with the portable terminal 1.

The sound output unit 23 outputs sound from a speaker based on a sound signal received from outside.

The authentication processing unit 24 transmits sound waves to inside of the ear, acquires a reverberation signal of the sound wave from the inner wall of the ear or the like, and outputs the reverberation signal to the portable terminal 1.

In the information processing system 100 described above, the portable terminal 1 is communicably connected to the earphone 2 and acquires the result of the authentication performed using the reverberation signal in the ear. In a case where acquisition of the predetermined first information is detected and the authentication result is the authentication success, the portable terminal 1 outputs the information regarding the execution of the predetermined processing executed by using the first information to the earphone 2. Here, the earphone 2 is a device that transmits information acquired from outside to the user in a state where the earphone 2 is worn by the user. Therefore, by using such an information processing system 100, when the user confirms information transmitted toward the user with the portable terminal 1, the user can confirm the information with higher confidentiality. Hereinafter, details of each processing of the portable terminal 1, the earphone 2, and the server 3 included in the information processing system 100 will be described.

### First Example Embodiment

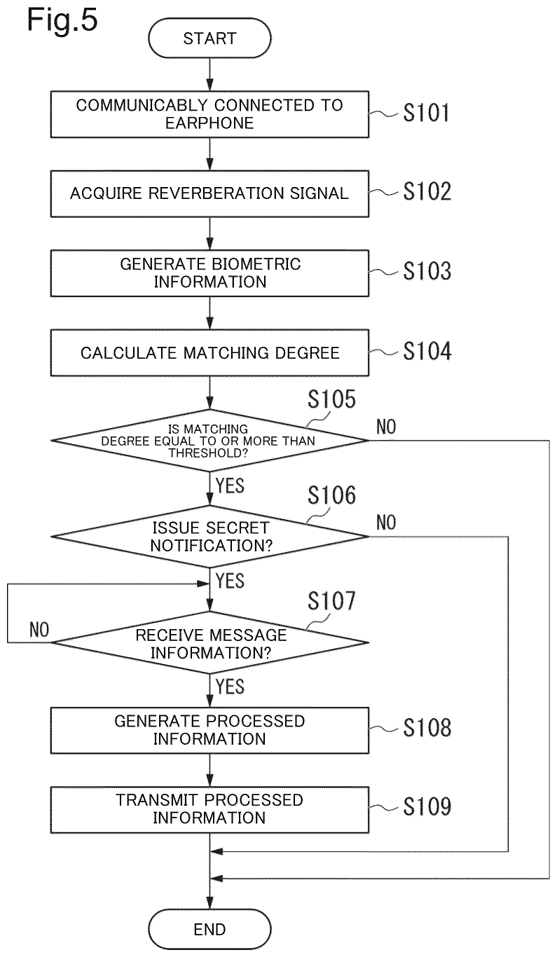

FIG. 5 is a first diagram illustrating a processing flow of a portable terminal according to one example embodiment of the present disclosure.

First, a communication connection unit 12 of a portable terminal 1 receives a connection signal output from a communication unit 22 of an earphone 2. Then, the communication connection unit 12 of the portable terminal 1 is communicably connected to the communication unit 22 of the earphone 2 (step S101). For this communication connection, a known communication connection technique such as Bluetooth (registered trademark) may be used. Upon detecting the communication connection with the portable terminal 1, a control unit 21 of the earphone 2 determines whether the earphone 2 is worn on a user's ear. For example, an infrared sensor is provided in the earphone 2, and it may be determined that the earphone 2 is worn in a case where the infrared sensor detects a proximity state with the ear. As a technique for determining whether the earphone 2 is worn on the user's ear, any technique may be used.

In a case of determining that the earphone 2 is worn on the user's ear, the control unit 21 of the earphone 2 instructs an authentication processing unit 24 to execute processing. The authentication processing unit 24 transmits sound waves from a speaker of the earphone 2. The authentication processing unit 24 acquires a reverberation signal and outputs the reverberation signal to the communication unit 22. The communication unit 22 transmits the reverberation signal to the portable terminal 1.

An authentication unit 13 of the portable terminal 1 acquires the reverberation signal received by the communication connection unit 12 (step S102). The authentication unit 13 generates biometric information of the user based on the reverberation signal (step S103). The reverberation signal is a sound signal specific for the user according to a shape of an inner wall of the user's ear or the like, and the biometric information generated based on the signal is recorded in a storage unit 17 of the portable terminal 1 in advance. The portable terminal 1 compares the biometric information generated based on the received reverberation signal with the biometric information recorded in the storage unit 17 in advance and calculates a matching degree (step S104). The authentication unit 13 determines whether the matching degree is equal to or more than a predetermined threshold (step S105). In a case where the matching degree is equal to or more than the predetermined threshold, the authentication unit 13 determines that authentication succeeds. The authentication unit 13 outputs information indicating the authentication success which is an authentication result to an authentication result acquisition unit 14. In a case where the authentication result does not indicate the authentication success, the authentication unit 13 does not need to output the information regarding the authentication result to the authentication result acquisition unit 14.

In the above processing, the authentication unit 13 of the portable terminal 1 executes authentication processing. However, the authentication processing unit 24 of the earphone 2 may calculate the matching degree by comparing the biometric information generated based on the reverberation signal and the biometric information recorded in the earphone 2 in advance, and may determine that authentication has succeeded in a case where the matching degree is equal to or more than a predetermined threshold. In this case, the authentication processing unit 24 of the earphone 2 may output the authentication result to the communication unit 22, and the communication unit 22 may output the authentication result to the portable terminal 1. In this case, it is not necessary to provide the authentication unit 13 in the portable terminal 1, and the authentication result acquisition unit 14 acquires the authentication result.

In a case of acquiring the authentication result indicating the authentication success, the authentication result acquisition unit 14 reads setting information from the storage unit 17. In the setting information, information indicating whether or not to issue a secret notification is recorded. The authentication result acquisition unit 14 determines whether the issuance of the secret notification is recorded in the setting information (step S106). In a case where the issuance of the secret notification is recorded in the setting information, the authentication result acquisition unit 14 instructs a detection unit 15 to start to process the secret notification. The processing on the secret notification is processing for transmitting predetermined information to the user via a device worn by the user such as the earphone 2, so as not to be confirmed by other users. Usually, the user unlocks a lock of a screen of the portable terminal 1, displays information held by the portable terminal 1 on the screen, and confirms the information. However, there is a case where a situation occurs in which the user does not desire that the others see such information. In such a case, the user inputs the issuance of the secret notification into the portable terminal 1. In this case, the control unit 11 writes the information indicating the issuance of the secret notification, in the setting information. In a case where the information indicating that the secret notification is not issued is recorded in the setting information, the authentication result acquisition unit 14 does not need to instruct the detection unit 15 to start to process the secret notification. In this case, it is sufficient for the user to unlock the lock of the screen and display and confirm the predetermined information.

Here, an example of the information indication that the portable terminal 1 issues the secret notification is message information transmitted from a server 3 to the portable terminal 1. The message information may be email information. The message information may be message information received from the server 3 by a predetermined message application program.

The detection unit 15 determines whether the message information has been received from the server 3 (step S107). The detection unit 15 acquires information indicating whether the message information has been received and the message information itself, from a message application program in the portable terminal 1 that handles the message information. In a case where the information indicating that the message information has been received or the message information itself has been received, the detection unit 15 determines to start to process the secret notification. The detection unit 15 outputs the message information to an execution unit 16.

When acquiring the message information, the execution unit 16 reads the setting information from the storage unit 17. The setting information may include information indicating which piece of information included in the message information is transmitted to the earphone 2. The information indicating which piece of the information included in the message information is transmitted to the earphone 2 may be information set and input by the user by using the portable terminal 1. The execution unit 16 generates processed information including one or a plurality of pieces of information, among the information included in the message information based on the setting information (step S108). For example, the execution unit 16 generates the processed information including information regarding only a transmission source user name or a transmission source user and a message body, included in the message information, based on the setting information. The execution unit 16 outputs the processed information to the communication connection unit 12. The communication connection unit 12 transmits the processed information to the earphone 2 (step S109).

It is sufficient for the execution unit 16 to process information obtained by copying predetermined piece of information included in the message information received from the server 3, as information that can be recognized by the earphone 2, and the processed information may include any piece of the information included in the message information. The communication connection unit 12 may be instructed to transmit the information to the earphone 2. These pieces of processed information are second information generated based on first information received from the server 3.

The communication unit 22 of the earphone 2 outputs the processed information received from the portable terminal 1 to a sound output unit 23. The sound output unit 23 converts character information included in the processed information into voice and outputs the voice from the speaker. In a case where the transmission source user and the message body are included in the processed information, the earphone 2 reads the transmission source user name and the message body aloud. That is, the processing of the portable terminal 1 is an example of an aspect in which the execution unit 16 reads the message information aloud based on the setting information stored in advance, specifies content read aloud, and outputs the processed information (second information) including the content read aloud to the earphone 2 (first terminal).

After receiving the processed information, the earphone 2 may determine whether the earphone 2 is worn on the user's ear again, and in a case where the earphone 2 is not worn, the earphone 2 may stop the output of the voice based on the processed information from the speaker. The earphone 2 continuously determines whether the earphone 2 is worn on the user's ear at every predetermined time, and in a case of determining that the earphone 2 is not worn on the user's ear, the earphone 2 may notify the portable terminal 1 of stop of the processing of the secret notification. In this case, the portable terminal 1 does not need to transmit the second information (processed information) generated based on the first information to the speaker 3.

According to the above processing, the portable terminal 1 is connected to the earphone 2 (first terminal) that has a structure for being worn on the user's ear and acquires the reflection signal (reverberation signal) of the signal output to the inside of the ear, which is the earphone 2 that transmits the information acquired from outside to the user in a case of being worn by the user, and acquires the result of the authentication performed by using the reflection signal. Then, the portable terminal 1 detects the acquisition of the message information (predetermined first information), and in a case where the authentication result indicates the authentication success, the portable terminal 1 outputs the processed information (information regarding execution of predetermined processing) processed using the message information to the earphone 2. According to such processing, the user can confirm the transmission source user name and the message body included in the processed information from the output of the speaker of the earphone 2 and can confirm the content of the message information received by the portable terminal 1, only by oneself, with no information seen by others. That is, by using the information processing system 100 including such a portable terminal 1, when confirming the information transmitted to the user by using the portable terminal 1, the user can confirm the information with higher confidentiality.

The execution unit 16 of the portable terminal 1 may output the processed information to the earphone 2 and may output the transmission source user name, a title, or the like included in the processed information to a lock screen of the own terminal, instead of the output of the processed information. The execution unit 16 of the portable terminal 1 may automatically unlock the lock screen of the own terminal, based on the acquisition of the first information. The execution unit 16 of the portable terminal 1 may automatically log into an application screen by the message application program that has received the first information.

In the above processing, the execution unit 16 of the portable terminal 1 generates the processed information including the predetermined piece of information such as the transmission source user name or the message body, included in the message information which is the first information, based on the setting information. However, the execution unit 16 may determine whether the message information has been received from a transmission source user name related to transmission source information, in a case where the transmission source information is included in the setting information, and may generate the processed information and transmit the processed information to the earphone 2, only in a case where the message information from the transmission source user name related to the transmission source information included in the setting information has been received.

### Second Example Embodiment

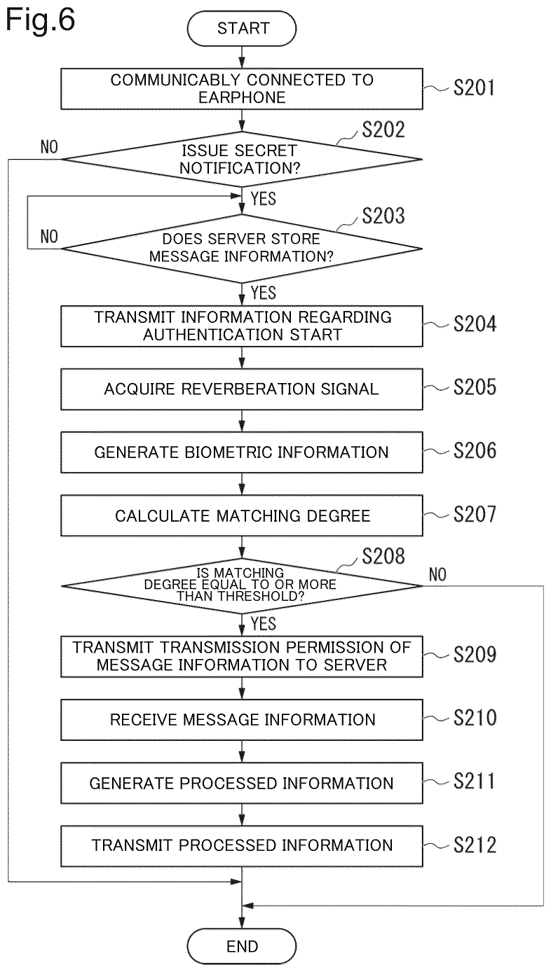

FIG. 6 is a second diagram illustrating a processing flow of a portable terminal according to one example embodiment of the present disclosure. Next, a processing flow of a portable terminal 1 according to a second example embodiment will be described.

First, a communication connection unit 12 of the portable terminal 1 receives a connection signal output from a communication unit 22 of an earphone 2, as described above. Then, the communication connection unit 12 of the portable terminal 1 is communicably connected to the communication unit 22 of the earphone 2 (step S201).

When detecting the communication connection between the portable terminal 1 and the earphone 2, a control unit 11 reads setting information from a storage unit 17. In the setting information, information indicating whether or not to process a secret notification is recorded. The control unit 11 determines whether issuance of the secret notification is recorded in the setting information (step S202). In a case where the issuance of the secret notification is recorded in the setting information, the control unit 11 instructs a detection unit 15 to start to process the secret notification.

Here, an example of the information indication that the portable terminal 1 issues the secret notification is message information transmitted from a server 3 to the portable terminal 1. The message information may be email information. The message information may be message information received from the server 3 by a predetermined message application program.

The detection unit 15 determines whether a notification indicating that message information received from another user is stored in the server 3, from the server 3 (step S203). In a case of receiving the notification indicating that the message information received from the another user is stored in the server 3 from the server 3, the detection unit 15 starts to process the secret notification. The detection unit 15 outputs information regarding authentication start to the communication connection unit 12. The communication connection unit 12 transmits the information regarding the authentication start to the earphone 2 (step S204).

A control unit 21 of the earphone 2 acquires the information regarding the authentication start via the communication unit 22. The control unit 21 instructs an authentication processing unit 24 to execute processing. The authentication processing unit 24 transmits sound waves from a speaker of the earphone 2. The authentication processing unit 24 acquires a reverberation signal and outputs the reverberation signal to the communication unit 22. The communication unit 22 transmits the reverberation signal to the portable terminal 1.

An authentication unit 13 of the portable terminal 1 acquires the reverberation signal received by the communication connection unit 12 (step S205). The authentication unit 13 generates biometric information of a user based on the reverberation signal (step S206). The portable terminal 1 compares the biometric information generated based on the received reverberation signal with biometric information recorded in the storage unit 17 in advance and calculates a matching degree (step S207). The authentication unit 13 determines whether the matching degree is equal to or more than a predetermined threshold (step S208). In a case where the matching degree is equal to or more than the predetermined threshold, the authentication unit 13 determines that authentication succeeds. The authentication unit 13 outputs information indicating the authentication success which is an authentication result to an authentication result acquisition unit 14. In a case where the authentication result does not indicate the authentication success, the authentication unit 13 does not need to output the information regarding the authentication result to the authentication result acquisition unit 14.

When acquiring the information indicating the authentication success, the authentication result acquisition unit 14 instructs a message application program in the portable terminal 1 that handles the message information to acquire the message information from the server 3. The message application program transmits a transmission permission of the message information stored in the server 3 to the server 3 (step S209). In this case, the authentication result acquisition unit 14 is one aspect of permission means for outputting the transmission permission to a transmission source of the message information (first information) based on the result of the authentication. Upon receiving the transmission permission from the portable terminal 1, the server 3 transmits the message information stored for the portable terminal 1, to the portable terminal 1. The message application program receives the message information (step S210).

The detection unit 15 acquires information indicating whether the message information has been received and the message information itself, from a message application program in the portable terminal 1 that handles the message information. In a case where the information indicating that the message information has been received or the message information itself has been received, the detection unit 15 determines to start to process the secret notification. The detection unit 15 outputs the message information to an execution unit 16.

When acquiring the message information, the execution unit 16 reads the setting information from the storage unit 17. The setting information may include information indicating which piece of information included in the message information is transmitted to the earphone 2. The information indicating which piece of the information included in the message information is transmitted to the earphone 2 may be information set and input by the user by using the portable terminal 1. The execution unit 16 generates processed information including one or a plurality of pieces of information, among the information included in the message information based on the setting information (step S211). For example, the execution unit 16 generates the processed information including information regarding only a transmission source user name or a transmission source user and a message body, included in the message information, based on the setting information. The execution unit 16 outputs the processed information to the communication connection unit 12. The communication connection unit 12 transmits the processed information to the earphone 2 (step S212).

It is sufficient for the execution unit 16 to process information obtained by copying predetermined piece of information included in the message information received from the server 3, as information that can be recognized by the earphone 2, and the processed information may include any piece of the information included in the message information. The communication connection unit 12 may be instructed to transmit the information to the earphone 2. These pieces of processed information are second information generated based on first information received from the server 3.

The communication unit 22 of the earphone 2 outputs the processed information received from the portable terminal 1 to a sound output unit 23. The sound output unit 23 converts character information included in the processed information into voice and outputs the voice from the speaker. In a case where the transmission source user and the message body are included in the processed information, the earphone 2 reads the transmission source user name and the message body aloud. That is, the processing of the portable terminal 1 is an example of an aspect in which the execution unit 16 reads the message information aloud based on the setting information stored in advance, specifies content read aloud, and outputs the processed information (second information) including the content read aloud to the earphone 2 (first terminal).

According to the above processing, the portable terminal 1 is connected to the earphone 2 (first terminal) that has a structure for being worn on the user's ear and acquires the reflection signal (reverberation signal) of the signal output to the inside of the ear, which is the earphone 2 that transmits the information acquired from outside to the user in a case of being worn by the user, and acquires the result of the authentication performed by using the reflection signal. Then, the portable terminal 1 detects the acquisition of the message information (predetermined first information), and in a case where the authentication result indicates the authentication success, the portable terminal 1 outputs the processed information (information regarding execution of predetermined processing) processed using the message information to the earphone 2. According to such processing, the user can confirm the transmission source user name and the message body included in the processed information from the output of the speaker of the earphone 2 and can confirm the content of the message information received by the portable terminal 1, only by oneself, with no information seen by others. That is, by using the information processing system 100 including such a portable terminal 1, when confirming the information transmitted to the user by using the portable terminal 1, the user can confirm the information with higher confidentiality.

### Third Example Embodiment

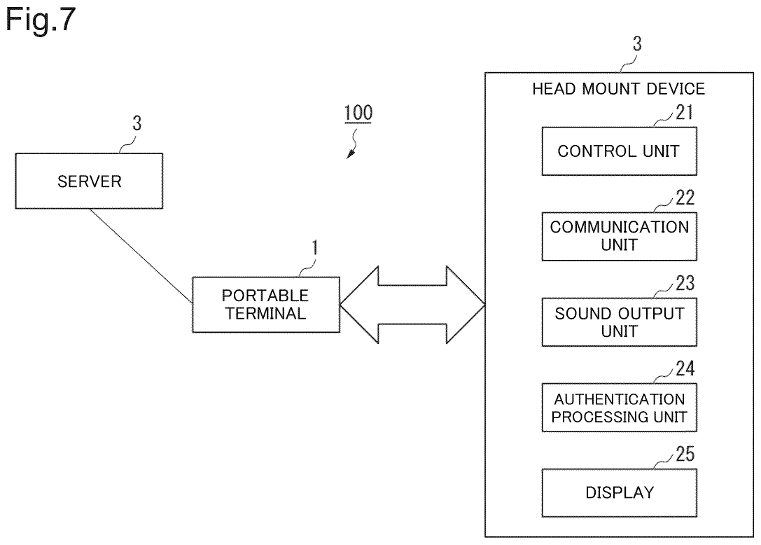

FIG. 7 is a functional block diagram of an information processing system according to one example embodiment of the present disclosure.

In the first and second example embodiments, an example of a case has been described where the earphone 2 acquires the reflection signal (reverberation signal) of the signal output to the inside of the ear and authenticates the user based on the reflection signal (reverberation signal). However, the earphone 2 may include, for example, a fingerprint sensor or a voiceprint sensor and a portable terminal 1 or the earphone 2 may execute authentication processing using biometric information such as a fingerprint or a voiceprint acquired by the earphone 2 based on these sensors.

In this case, the portable terminal 1 is connected to the earphone 2 (first terminal) that acquires the biometric information of the user, which transmits information acquired from outside to the user in a state of being worn by the user, and acquires a result of the authentication performed by using the biometric information. Then, the portable terminal 1 detects acquisition of predetermined first information (for example, message information), and in a case where the result of the authentication indicates an authentication success, the portable terminal 1 outputs information (processed information) regarding execution of predetermined processing executed using the first information to the earphone 2 (first terminal).

In this case, the user can confirm a transmission source user name and a message body included in the processed information from an output of a speaker of the earphone 2 and can confirm content of the message information received by the portable terminal 1, only by oneself, with no information seen by others. That is, by using the information processing system 100 including such a portable terminal 1, when confirming the information transmitted to the user by using the portable terminal 1, the user can confirm the information with higher confidentiality.

In a case of the third example embodiment, since it is not necessary to acquire the reverberation signal in the ear, instead of the earphone 2, a head mount terminal 4 or a headphone 5 may be communicably connected to the portable terminal 1 and be included in the information processing system 100. The headphone 5 has a function similar to the earphone. The head mount terminal 4 includes a display 25 in addition to each function of the earphone 2.

In a case where the portable terminal 1 is communicably connected to the head mount terminal 4, instead of the earphone 2, the portable terminal 1 transmits the processed information to the head mount terminal 4. A control unit 21 of the head mount terminal 4 may display the transmission source user name and the message body included in the processed information, on the display 25 provided on an inner surface of a goggle portion (inner surface of glass of goggles that user's eyes directly and visually recognize) of the head mount terminal 4.

### Fourth Example Embodiment

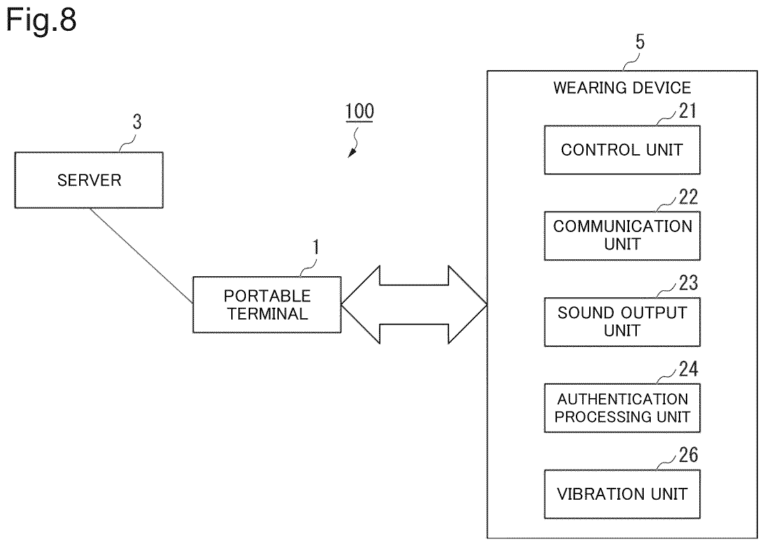

FIG. 8 is a functional block diagram of an information processing system according to one example embodiment of the present disclosure.

Regarding a terminal that acquires biometric information of a user and transmits information acquired from outside to the user in a state of being worn by the user, in the above example embodiments, examples of cases of the earphone 2, the head mount terminal 4, and the headphone 5 have been described. However, the terminal may be another wearing device 5 that can be worn on a part of a body such as an arm, a waist, or a leg. In this case, the wearing device 5 includes a vibration unit 26. Then, in a case where a portable terminal 1 is communicably connected to the wearing device 5, when the portable terminal 1 transmits processed information to the wearing device 5, the vibration unit 26 of the wearing device 5 may generate vibration of a vibration pattern related to a transmission source user name included in the processed information, with a vibrator. An authentication processing unit 24 of the wearing device 5 may include a fingerprint sensor, acquire a fingerprint of the user as biometric information for authentication processing, and transmit the fingerprint to the portable terminal 1.

### Fifth Example Embodiment

An execution unit 16 of a portable terminal 1 may output an information request based on reception of acquired first information, as second information, to a first terminal (earphone 2 or the like) and output response information transmitted based on the information request by the first terminal, to another device.

Hereinafter, an example will be described in which the earphone 2 stores card information in advance and transmits the card information, as the response information, to the portable terminal 1, and the portable terminal 1 transmits the response information to a predetermined device.

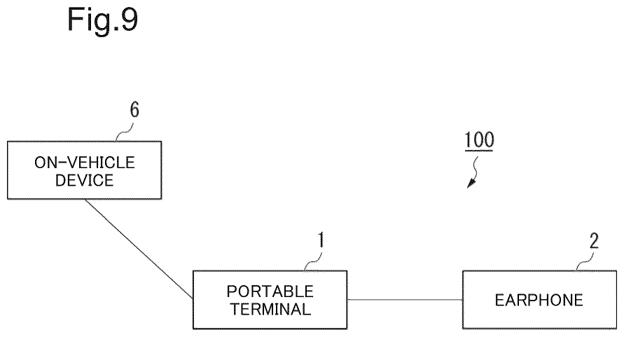

FIG. 9 is a functional block diagram of an information processing system according to one example embodiment of the present disclosure.

As illustrated in FIG. 9, an information processing system 100 may be configured such that the portable terminal 1 is connected to an on-vehicle device 6 and the earphone 2. The on-vehicle device 6 outputs the first information to the portable terminal 1. The portable terminal 1 outputs the second information generated by processing the first information acquired from the on-vehicle device 6, to the earphone 2. The earphone 2 converts the second information into sound and transmits the sound to a user. The earphone 2 transmits the response information related to the second information to the portable terminal 1. The portable terminal 1 transmits the response information to the on-vehicle device 6. The first information is, for example, an inquiry signal based on reception of an ETC signal. The second information is a transmission request of credit card information generated based on the inquiry signal.

The earphone 2 stores a card number as the credit card information in advance. The earphone 2 transmits the card number as the response information to the portable terminal 1. The portable terminal 1 transmits the card number acquired from the earphone 2 to the on-vehicle device 6, in response to the inquiry signal. The on-vehicle device 6 communicates with an ETC system using the card number and executes payment processing of expressway tolls or the like.

In a fifth example embodiment, a hardware configuration of the portable terminal 1, the on-vehicle device 6, or the like is similar to the configuration illustrated in FIG. 3. In a sixth example embodiment, functional block diagrams of the portable terminal 1 and the earphone 2 are similar.

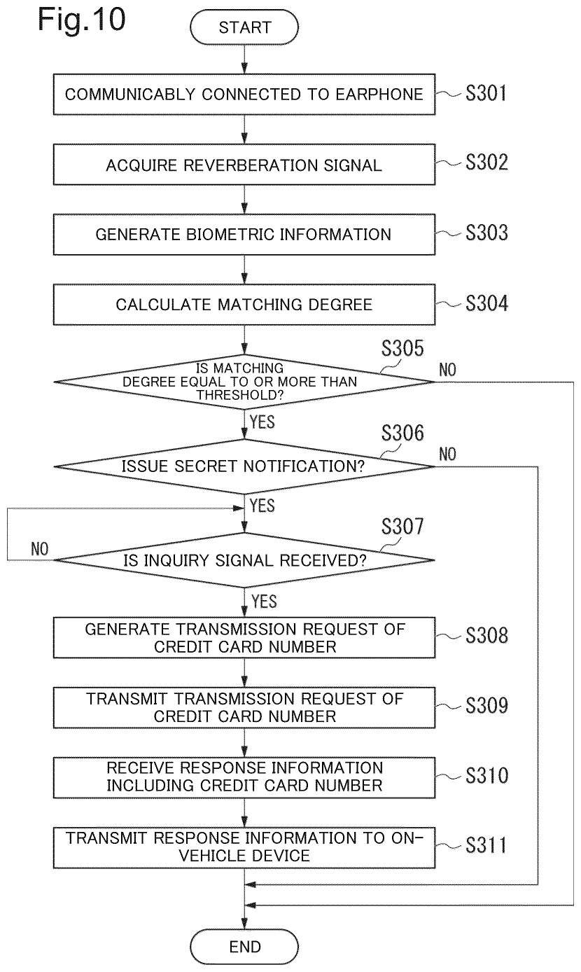

FIG. 10 is a third diagram illustrating a processing flow of a portable terminal according to one example embodiment of the present disclosure.

First, a communication connection unit 12 of a portable terminal 1 receives a connection signal output from a communication unit 22 of an earphone 2. Then, the communication connection unit 12 of the portable terminal 1 is communicably connected to the communication unit 22 of the earphone 2 (step S301). Similarly to the above, for this communication connection, a known communication connection technique such as Bluetooth (registered trademark) may be used. Upon detecting the communication connection with the portable terminal 1, a control unit 21 of the earphone 2 determines whether the earphone 2 is worn on a user's ear. For example, an infrared sensor is provided in the earphone 2, and it may be determined that the earphone 2 is worn in a case where the infrared sensor detects a proximity state with the ear. As a technique for determining whether the earphone 2 is worn on the user's ear, any technique may be used.

In a case of determining that the earphone 2 is worn on the user's ear, the control unit 21 of the earphone 2 instructs an authentication processing unit 24 to execute processing. The authentication processing unit 24 transmits sound waves from a speaker of the earphone 2. The authentication processing unit 24 acquires a reverberation signal and outputs the reverberation signal to the communication unit 22. The communication unit 22 transmits the reverberation signal to the portable terminal 1.

An authentication unit 13 of the portable terminal 1 acquires the reverberation signal received by the communication connection unit 12 (step S302). The authentication unit 13 generates biometric information of the user based on the reverberation signal (step S303). The reverberation signal is a sound signal specific for the user according to a shape of an inner wall of the user's ear or the like, and the biometric information generated based on the signal is recorded in a storage unit 17 of the portable terminal 1 in advance. The portable terminal 1 compares the biometric information generated based on the received reverberation signal with the biometric information recorded in the storage unit 17 in advance and calculates a matching degree (step S304). The authentication unit 13 determines whether the matching degree is equal to or more than a predetermined threshold (step S305). In a case where the matching degree is equal to or more than the predetermined threshold, the authentication unit 13 determines that authentication succeeds. The authentication unit 13 outputs information indicating the authentication success which is an authentication result to an authentication result acquisition unit 14. In a case where the authentication result does not indicate the authentication success, the authentication unit 13 does not need to output the information regarding the authentication result to the authentication result acquisition unit 14.

In the above processing, the authentication unit 13 of the portable terminal 1 executes authentication processing.

However, the authentication processing unit 24 of the earphone 2 may calculate the matching degree by comparing the biometric information generated based on the reverberation signal and the biometric information recorded in the earphone 2 in advance, and may determine that authentication has succeeded in a case where the matching degree is equal to or more than a predetermined threshold. In this case, the authentication processing unit 24 of the earphone 2 may output the authentication result to the communication unit 22, and the communication unit 22 may output the authentication result to the portable terminal 1. In this case, it is not necessary to provide the authentication unit 13 in the portable terminal 1, and the authentication result acquisition unit 14 acquires the authentication result.

In a case of acquiring the authentication result indicating the authentication success, the authentication result acquisition unit 14 reads setting information from the storage unit 17. In the setting information, information indicating whether or not to issue a secret notification is recorded. The authentication result acquisition unit 14 determines whether the issuance of the secret notification is recorded in the setting information (step S306). In a case where the issuance of the secret notification is recorded in the setting information, the authentication result acquisition unit 14 instructs a detection unit 15 to start to process the secret notification. In a case where the information indicating that the secret notification is not issued is recorded in the setting information, the authentication result acquisition unit 14 does not need to instruct the detection unit 15 to start to process the secret notification.

In a case where the on-vehicle device 6 communicates with the ETC system at an entrance of the expressway or the like, the on-vehicle device 6 acquires a card number from a credit card inserted into the on-vehicle device 6 and transmits the card number to the ETC system. However, in a case where the credit card is not inserted into the on-vehicle device 6, it is not possible for the on-vehicle device 6 to transmit the card number to the ETC system. The on-vehicle device 6 determines whether the credit card is inserted into the device. In a case where the credit card is not inserted into the on-vehicle device 6, the on-vehicle device 6 transmits the inquiry signal to the portable terminal 1. The on-vehicle device 6 may be communicably connected to the portable terminal 1 in advance.

The detection unit 15 of the portable terminal 1 determines whether the inquiry signal has been received (step S307). Upon acquiring the inquiry signal, the detection unit 15 determines to start to process the secret notification. The detection unit 15 outputs the inquiry signal to the execution unit 16. When acquiring the inquiry signal, the execution unit 16 generates a transmission request of the credit card number (step S308). The execution unit 16 outputs the transmission request of the credit card number to the communication connection unit 12. The communication connection unit 12 transmits the transmission request to the earphone 2 (step S309). The transmission request is one aspect of the second information (processed information) generated based on the reception of the inquiry signal which is the first information.

The control unit 21 of the earphone 2 outputs the transmission request received by the communication unit 22 from the portable terminal 1 to a sound output unit 23. The sound output unit 23 outputs voice related to the transmission request from the speaker. The voice related to the transmission request may be, for example, “A credit card number is transmitted to an on-vehicle device” or the like. As a result, the user can securely grasp that the on-vehicle device 6 acquires information regarding the credit card number from the earphone 2.

The control unit 21 of the earphone 2 reads the credit card number recorded in a storage unit of the earphone 2. The control unit 21 outputs the response information including the credit card number to the communication unit 22. The communication unit 22 transmits the response information to the portable terminal 1. The execution unit 16 of the portable terminal 1 receives the response information (step S310). The execution unit 16 of the portable terminal 1 transmits the received response information to the on-vehicle device 6 (step S311).

The on-vehicle device 6 receives the response information. The on-vehicle device 6 transmits the credit card number included in the response information to the ETC system. As a result, even in a case where the credit card is not inserted into the on-vehicle device 6, since the credit card number is recorded in the earphone 2, it is possible to perform payment for traveling on a toll road using the ETC system, instead of the credit card.

### Sixth Example Embodiment

In a case of detecting sound as first information, an execution unit 16 of a portable terminal 1 may output second information (processed information) generated based on the sound to an output destination such as an earphone 2. For example, it is assumed that a ticket gate machine installed at a ticket gate of a station periodically emit sound. When the portable terminal 1 detects the sound, the execution unit 16 reads remaining payment information stored in a cashless payment application program included in the portable terminal 1 and generates notification information including the remaining payment information as the processed information. The execution unit 16 transmits the notification information to the earphone 2. The earphone 2 reads the remaining payment information included in the notification information aloud and outputs the information as voice from the speaker. Hereinafter, details of processing of a sixth example embodiment will be described.

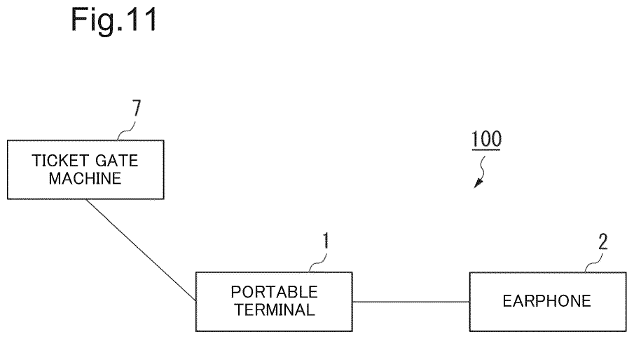

FIG. 11 is a functional block diagram of an information processing system according to one example embodiment of the present disclosure.

As illustrated in FIG. 11, an information processing system 100 is configured such that the portable terminal 1 is connected to a ticket gate machine 7 and the earphone 2. In the sixth example embodiment, a hardware configuration of the portable terminal 1 may be similar to the configuration illustrated in FIG. 3. In a sixth example embodiment, functional block diagrams of the portable terminal 1 and the earphone 2 are similar.

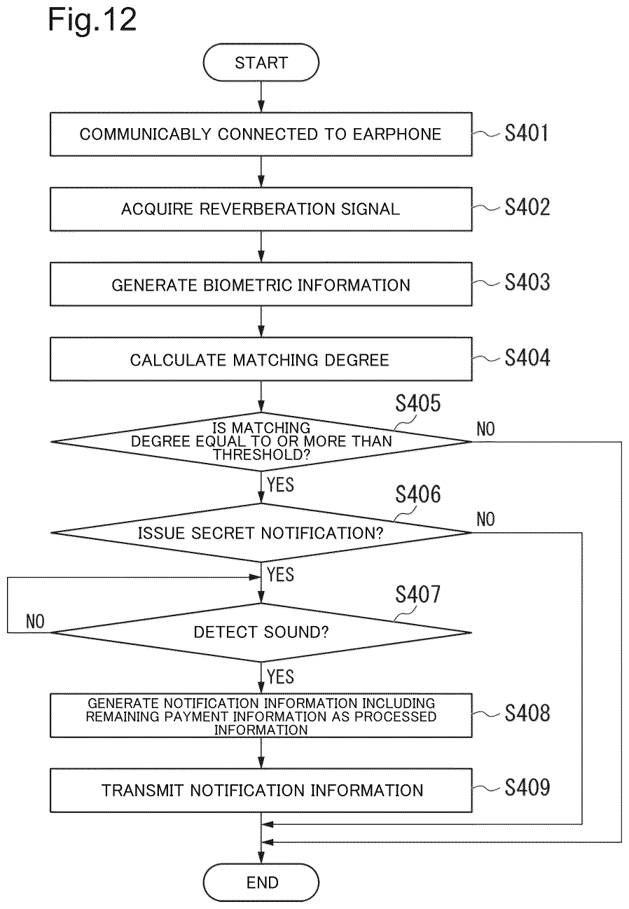

FIG. 12 is a fourth diagram illustrating a processing flow of the portable terminal according to one example embodiment of the present disclosure.

First, a communication connection unit 12 of a portable terminal 1 receives a connection signal output from a communication unit 22 of an earphone 2. Then, the communication connection unit 12 of the portable terminal 1 is communicably connected to the communication unit 22 of the earphone 2 (step S401). Similarly to the above, for this communication connection, a known communication connection technique such as Bluetooth (registered trademark) may be used. Upon detecting the communication connection with the portable terminal 1, a control unit 21 of the earphone 2 determines whether the earphone 2 is worn on a user's ear. For example, an infrared sensor is provided in the earphone 2, and it may be determined that the earphone 2 is worn in a case where the infrared sensor detects a proximity state with the ear. As a technique for determining whether the earphone 2 is worn on the user's ear, any technique may be used.

In a case of determining that the earphone 2 is worn on the user's ear, the control unit 21 of the earphone 2 instructs an authentication processing unit 24 to execute processing. The authentication processing unit 24 transmits sound waves from a speaker of the earphone 2. The authentication processing unit 24 acquires a reverberation signal and outputs the reverberation signal to the communication unit 22. The communication unit 22 transmits the reverberation signal to the portable terminal 1.

An authentication unit 13 of the portable terminal 1 acquires the reverberation signal received by the communication connection unit 12 (step S402). The authentication unit 13 generates biometric information of the user based on the reverberation signal (step S403). The reverberation signal is a sound signal specific for the user according to a shape of an inner wall of the user's ear or the like, and the biometric information generated based on the signal is recorded in a storage unit 17 of the portable terminal 1 in advance. The portable terminal 1 compares the biometric information generated based on the received reverberation signal with the biometric information recorded in the storage unit 17 in advance and calculates a matching degree (step S404). The authentication unit 13 determines whether the matching degree is equal to or more than a predetermined threshold (step S405). In a case where the matching degree is equal to or more than the predetermined threshold, the authentication unit 13 determines that authentication succeeds. The authentication unit 13 outputs information indicating the authentication success which is an authentication result to an authentication result acquisition unit 14. In a case where the authentication result does not indicate the authentication success, the authentication unit 13 does not need to output the information regarding the authentication result to the authentication result acquisition unit 14.

In the above processing, the authentication unit 13 of the portable terminal 1 executes authentication processing.

However, the authentication processing unit 24 of the earphone 2 may calculate the matching degree by comparing the biometric information generated based on the reverberation signal and the biometric information recorded in the earphone 2 in advance, and may determine that authentication has succeeded in a case where the matching degree is equal to or more than a predetermined threshold. In this case, the authentication processing unit 24 of the earphone 2 may output the authentication result to the communication unit 22, and the communication unit 22 may output the authentication result to the portable terminal 1. In this case, it is not necessary to provide the authentication unit 13 in the portable terminal 1, and the authentication result acquisition unit 14 acquires the authentication result.

In a case of acquiring the authentication result indicating the authentication success, the authentication result acquisition unit 14 reads setting information from the storage unit 17. In the setting information, information indicating whether or not to issue a secret notification is recorded. The authentication result acquisition unit 14 determines whether the issuance of the secret notification is recorded in the setting information (step S406). In a case where the issuance of the secret notification is recorded in the setting information, the authentication result acquisition unit 14 instructs a detection unit 15 to start to process the secret notification. In a case where the information indicating that the secret notification is not issued is recorded in the setting information, the authentication result acquisition unit 14 does not need to instruct the detection unit 15 to start to process the secret notification.

As described above, the ticket gate machine 7 periodically emits sound. The detection unit 15 of the portable terminal 1 determines whether the sound emitted by the ticket gate machine 7 has been detected (step S407). Upon detecting the sound, the detection unit 15 determines to start to process the secret notification. The detection unit 15 outputs the detection of the sound to the execution unit 16. When acquiring information regarding the sound detection, the execution unit 16 requests the cashless payment application program to notify the remaining payment information. The cashless payment application program outputs the remaining payment information stored in a memory or the like to the execution unit 16. The execution unit 16 generates the notification information including the remaining payment information as the processed information (step S408).

The execution unit 16 outputs the notification information to the communication connection unit 12. The communication connection unit 12 transmits the notification information to the earphone 2 (step S409). The notification information is one aspect of the second information (processed information) generated based on the sound detection which is the first information.

The control unit 21 of the earphone 2 outputs the notification information received by the communication unit 22 from the portable terminal 1 to a sound output unit 23. The sound output unit 23 outputs related voice based on the remaining payment information included in the notification information from the speaker. The voice related to the remaining payment information may be, for example, “The balance is 5000 yen” or the like. As a result, the user can securely grasp the remaining payment information of the cashless payment application program of the portable terminal 1.

### Seventh Example Embodiment

In a case of detecting first information indicating activation of a predetermined application program, an execution unit 16 of a portable terminal 1 may output a result of execution by the predetermined application program based on the detection of the first information to an output destination such as an earphone 2. For example, it is assumed that the portable terminal 1 have a function of a sentence reading application for reading sentences of a book aloud. When the portable terminal 1 detects activation of a sentence reading application program, when the sentence reading application starts sentence reading from a part where the application has stopped reproduction last time, the execution unit 16 automatically transmits voice information of the sentence reading to the earphone 2. The earphone 2 outputs the voice information to a speaker. This processing is also one aspect of processing for outputting information regarding execution of predetermined processing executed by the portable terminal 1 using the first information to the earphone 2. That is, the first information relates to the information indicating the activation of the sentence reading application, and the execution of the predetermined processing relates to the transmission of the voice information of the sentence reading start from the part where the sentence reading application has stopped the reproduction last time, to the earphone 2. Hereinafter, details of processing of a seventh example embodiment will be described.

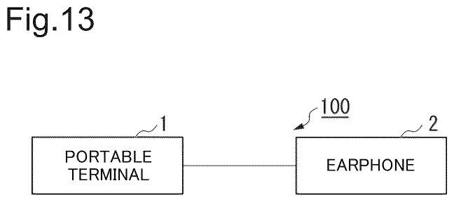

FIG. 13 is a functional block diagram of an information processing system according to one example embodiment of the present disclosure.

As illustrated in FIG. 13, an information processing system 100 is configured such that the portable terminal 1 is connected to the earphone 2. In the seventh example embodiment, a hardware configuration of the portable terminal 1 may be similar to the configuration illustrated in FIG. 3. In a sixth example embodiment, functional block diagrams of the portable terminal 1 and the earphone 2 are similar.

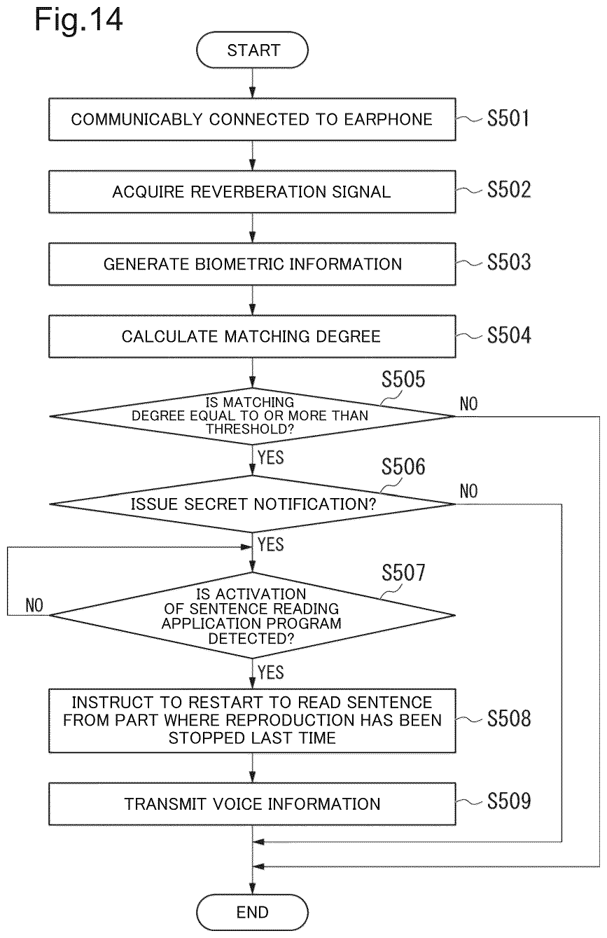

FIG. 14 is a fifth diagram illustrating a processing flow of the portable terminal according to one example embodiment of the present disclosure.

First, a communication connection unit 12 of a portable terminal 1 receives a connection signal output from a communication unit 22 of an earphone 2. Then, the communication connection unit 12 of the portable terminal 1 is communicably connected to the communication unit 22 of the earphone 2 (step S501). Similarly to the above, for this communication connection, a known communication connection technique such as Bluetooth (registered trademark) may be used. Upon detecting the communication connection with the portable terminal 1, a control unit 21 of the earphone 2 determines whether the earphone 2 is worn on a user's ear. For example, an infrared sensor is provided in the earphone 2, and it may be determined that the earphone 2 is worn in a case where the infrared sensor detects a proximity state with the ear. As a technique for determining whether the earphone 2 is worn on the user's ear, any technique may be used.

In a case of determining that the earphone 2 is worn on the user's ear, the control unit 21 of the earphone 2 instructs an authentication processing unit 24 to execute processing. The authentication processing unit 24 transmits sound waves from a speaker of the earphone 2. The authentication processing unit 24 acquires a reverberation signal and outputs the reverberation signal to the communication unit 22. The communication unit 22 transmits the reverberation signal to the portable terminal 1.

An authentication unit 13 of the portable terminal 1 acquires the reverberation signal received by the communication connection unit 12 (step S502). The authentication unit 13 generates biometric information of the user based on the reverberation signal (step S503). The reverberation signal is a sound signal specific for the user according to a shape of an inner wall of the user's ear or the like, and the biometric information generated based on the signal is recorded in a storage unit 17 of the portable terminal 1 in advance. The portable terminal 1 compares the biometric information generated based on the received reverberation signal with the biometric information recorded in the storage unit 17 in advance and calculates a matching degree (step S504). The authentication unit 13 determines whether the matching degree is equal to or more than a predetermined threshold (step S505). In a case where the matching degree is equal to or more than the predetermined threshold, the authentication unit 13 determines that authentication succeeds. The authentication unit 13 outputs information indicating the authentication success which is an authentication result to an authentication result acquisition unit 14. In a case where the authentication result does not indicate the authentication success, the authentication unit 13 does not need to output the information regarding the authentication result to the authentication result acquisition unit 14.

In the above processing, the authentication unit 13 of the portable terminal 1 executes authentication processing.

However, the authentication processing unit 24 of the earphone 2 may calculate the matching degree by comparing the biometric information generated based on the reverberation signal and the biometric information recorded in the earphone 2 in advance, and may determine that authentication has succeeded in a case where the matching degree is equal to or more than a predetermined threshold. In this case, the authentication processing unit 24 of the earphone 2 may output the authentication result to the communication unit 22, and the communication unit 22 may output the authentication result to the portable terminal 1. In this case, it is not necessary to provide the authentication unit 13 in the portable terminal 1, and the authentication result acquisition unit 14 acquires the authentication result.

In a case of acquiring the authentication result indicating the authentication success, the authentication result acquisition unit 14 reads setting information from the storage unit 17. In the setting information, information indicating whether or not to issue a secret notification is recorded. The authentication result acquisition unit 14 determines whether the issuance of the secret notification is recorded in the setting information (step S506). In a case where the issuance of the secret notification is recorded in the setting information, the authentication result acquisition unit 14 instructs a detection unit 15 to start to process the secret notification. In a case where the information indicating that the secret notification is not issued is recorded in the setting information, the authentication result acquisition unit 14 does not need to instruct the detection unit 15 to start to process the secret notification.

A detection unit 15 of the portable terminal 1 determines whether the portable terminal 1 has detected the activation of the sentence reading application program (step S507). The detection of the activation is an example of detection of acquisition of predetermined first information. Upon detecting the activation of the sentence reading application program, the detection unit 15 determines to start to process the secret notification. The detection unit 15 outputs the detection of the activation of the sentence reading application program to the execution unit 16. When acquiring the information indicating the detection of the activation of the sentence reading application program, the execution unit 16 instructs to restart to read the sentence from the part where the sentence reading application has stopped reproduction last time (step S508). The sentence reading application program reads the part where the reproduction has been stopped last time from a memory or the like and starts reading from a sentence related to the part. The execution unit 16 outputs the voice information generated by reading to the communication connection unit 12. The communication connection unit 12 transmits the voice information to the earphone 2 (step S509).

The control unit 21 of the earphone 2 outputs the voice information received by the communication unit 22 from the portable terminal 1 to a sound output unit 23. The sound output unit 23 outputs the voice information from the speaker. As a result, the user can securely listen to the reading of the sentence from the part where the reproduction has been stopped last time, only by activating the sentence reading application on the portable terminal 1.

### Eighth Example Embodiment

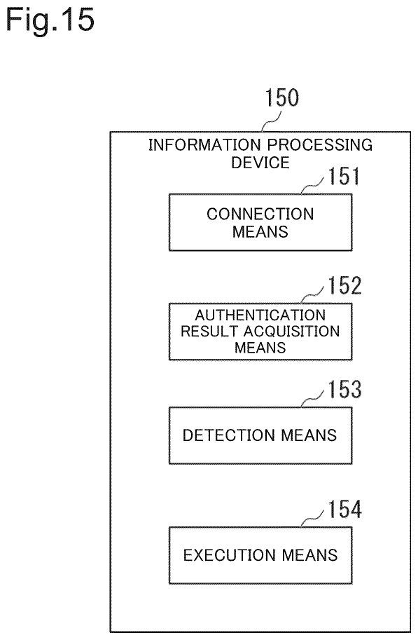

FIG. 15 is a functional block diagram illustrating a minimum configuration of an information processing device according to one example embodiment of the present disclosure.

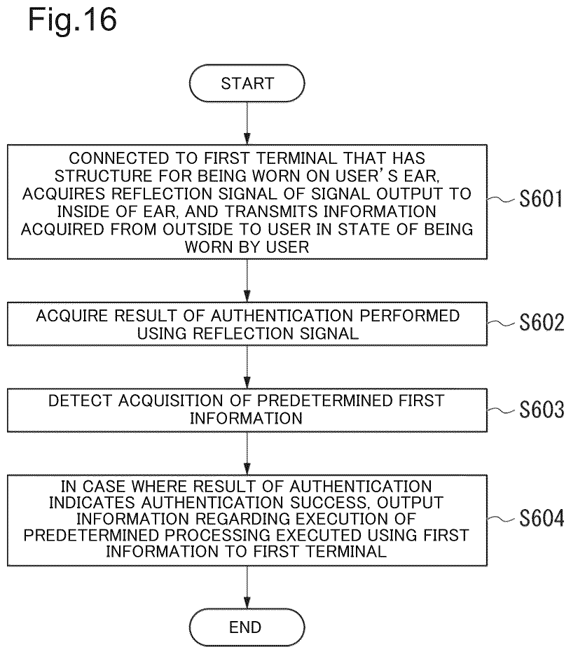

FIG. 16 is a diagram illustrating a processing flow by the information processing device having the minimum configuration according to one example embodiment of the present disclosure.

An information processing device 150 has at least functions of connection means 151, authentication result acquisition means 152, detection means 153, and execution means 154. The portable terminal 1 according to the other example embodiments described above is an aspect of the information processing device 150.

The connection means 151 is connected to a first terminal that has a structure for being worn on a user's ear, acquires a reflection signal of a signal output to inside of the ear, and transmits information acquired from outside to the user in a case of being worn by the user (step S601).

The authentication result acquisition means 152 acquires a result of authentication performed using the reflection signal (step S602).

The detection means 153 detects acquisition of predetermined first information (step S603).

In a case where the result of the authentication indicates an authentication success, the execution means 154 outputs information regarding execution of predetermined processing executed using the first information to the first terminal (step S604).

A program of the portable terminal 1 may achieve some of the above functions. In addition, the above-described function may be achieved by a combination with a program already recorded in a computer system, that is, a so-called difference file (difference program).

While an information processing system 100 according to the present disclosure has been described, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Some or all of the above example embodiments may be described as the following Supplementary Notes, but are not limited to the following.

### Supplementary Note 1

An information processing device including: connection means for being connected to a first terminal that has a structure for being worn on a user's ear, acquires a reflection signal of a signal output to inside of the ear, and transmits information acquired from outside to a user in a state of being worn by the user;
authentication result acquisition means for acquiring a result of authentication performed using the reflection signal;
detection means for detecting acquisition of predetermined first information; and
execution means for outputting information regarding execution of predetermined processing executed using the first information to the first terminal, in a case where the result of the authentication is an authentication success.

### Supplementary Note 2

The information processing device according to supplementary note 1, in which vin a case where the result of the authentication is the authentication success, the execution means outputs second information generated based on the first information to the first terminal.

### Supplementary Note 3

The information processing device according to supplementary note 2, in which
the first information is message information, and
the second information is processed information obtained by processing the message information.

### Supplementary Note 4

The information processing device according to supplementary note 3, further including:
permission means for outputting a transmission permission to a transmission source of the first information based on the result of the authentication, in which
the detection means detects the first information from the transmission source based on the transmission permission.

### Supplementary Note 5

The information processing device according to supplementary note 3 or 4, in which
the execution means specifies reading content of the message information based on setting information stored in advance and outputs the second information including the reading content to the first terminal.

### Supplementary Note 6

The information processing device according to supplementary note 2, in which
the detection means detects first information transmitted from another device, and
the execution means outputs an information request according to the first information as the second information to the first terminal and outputs response information received from the first terminal based on the information request to the another device.

### Supplementary Note 7

The information processing device according to supplementary note 2, in which
the first information is sound, and
the execution means outputs the second information generated based on the sound to the first terminal.

### Supplementary Note 8

An information processing device including:
connection means for being connected to each of a first terminal that has a structure for being worn on a user's ear and acquires a reflection signal of a signal output to inside of the ear and a second terminal that transmits information acquired from outside to a user in a state of being worn by the user;
authentication result acquisition means for acquiring a result of authentication performed using the reflection signal;
detection means for detecting acquisition of predetermined first information; and
execution means for outputting information regarding execution of predetermined processing executed using the first information to the second terminal, in a case where the result of the authentication is an authentication success.

### Supplementary Note 9

The information processing device according to supplementary note 8, in which
in a case where the result of the authentication is the authentication success, the execution means outputs second information generated based on the first information to the second terminal.

### Supplementary Note 10

The information processing device according to supplementary note 9, in which
the first information is message information, and
the second information is processed information obtained by processing the message information.

### Supplementary Note 11

The information processing device according to supplementary note 10, further including:
permission means for outputting a transmission permission to a transmission source of the first information based on the result of the authentication, in which
the detection means detects the first information from the transmission source based on the transmission permission.

### Supplementary Note 12

The information processing device according to supplementary note 10 or 11, in which
the execution means specifies reading content of the message information based on setting information stored in advance and outputs the second information including the reading content to the second terminal.

### Supplementary Note 13

The information processing device according to supplementary note 9, in which
the detection means detects first information transmitted from another device, and
the execution means outputs an information request according to the first information as the second information to the second terminal and outputs response information received from the second terminal based on the information request to the another device.

### Supplementary Note 14

The information processing device according to supplementary note 9, in which
the first information is sound, and
the execution means outputs the second information generated based on the sound to the second terminal.

### Supplementary Note 15

A portable terminal including:
connection means for being connected to a first terminal that has a structure for being worn on a user's ear, acquires a reflection signal of a signal output to inside of the ear, and transmits information acquired from outside to a user in a state of being worn by the user;
authentication result acquisition means for acquiring a result of authentication performed using the reflection signal;
detection means for detecting acquisition of predetermined first information; and
execution means for outputting information regarding execution of predetermined processing executed using the first information to the first terminal, in a case where the result of the authentication is an authentication success.

### Supplementary Note 16

The portable terminal according to supplementary note 15, in which
in a case where the result of the authentication is the authentication success, the execution means outputs second information generated based on the first information to the first terminal.

### Supplementary Note 17

The portable terminal according to supplementary note 16, in which
the first information is message information, and
the second information is processed information obtained by processing the message information.

### Supplementary Note 18

The portable terminal according to supplementary note 17, further including:
permission means for outputting a transmission permission to a transmission source of the first information based on the result of the authentication, in which
the detection means detects the first information from the transmission source based on the transmission permission.

### Supplementary Note 19

The portable terminal according to supplementary note 17 or 18, in which
the execution means specifies reading content of the message information based on setting information stored in advance and outputs the second information including the reading content to the first terminal.

### Supplementary Note 20

The portable terminal according to supplementary note 16, in which
the detection means detects first information transmitted from another device, and
the execution means outputs an information request according to the first information as the second information to the first terminal and outputs response information received from the first terminal based on the information request to the another device.

### Supplementary Note 21

The portable terminal according to supplementary note 16, in which
the first information is sound, and
the execution means outputs the second information generated based on the sound to the first terminal.

### Supplementary Note 22

A portable terminal including:
connection means for being connected to each of a first terminal that has a structure for being worn on a user's ear and acquires a reflection signal of a signal output to inside of the ear and a second terminal that transmits information acquired from outside to a user in a state of being worn by the user;
authentication result acquisition means for acquiring a result of authentication performed using the reflection signal;
detection means for detecting acquisition of predetermined first information; and
execution means for outputting information regarding execution of predetermined processing executed using the first information to the second terminal, in a case where the result of the authentication is an authentication success.

### Supplementary Note 23

The portable terminal according to supplementary note 22, in which
in a case where the result of the authentication is the authentication success, the execution means outputs second information generated based on the first information to the first terminal.

### Supplementary Note 24

The portable terminal according to supplementary note 23, in which
the first information is message information, and
the second information is processed information obtained by processing the message information.

### Supplementary Note 25

The portable terminal according to supplementary note 24, further including:
permission means for outputting a transmission permission to a transmission source of the first information based on the result of the authentication, in which
the detection means detects the first information from the transmission source based on the transmission permission.

### Supplementary Note 26

The portable terminal according to supplementary note 24 or 25, in which
the execution means specifies reading content of the message information based on setting information stored in advance and outputs the second information including the reading content to the first terminal.

### Supplementary Note 27

The portable terminal according to supplementary note 23, in which
the detection means detects first information transmitted from another device, and
the execution means outputs an information request according to the first information as the second information to the first terminal and outputs response information received from the first terminal based on the information request to the another device.

### Supplementary Note 28

The portable terminal according to supplementary note 23, in which
the first information is sound, and
the execution means outputs the second information generated based on the sound to the first terminal.

### Supplementary Note 29

An information processing method including:
being connected to a first terminal that has a structure for being worn on a user's ear, acquires a reflection signal of a signal output to inside of the ear, and transmits information acquired from outside to a user in a state of being worn by the user;
acquiring a result of authentication performed using the reflection signal;
detecting acquisition of predetermined first information; and
outputting information regarding execution of predetermined processing executed using the first information to the first terminal, in a case where the result of the authentication is an authentication success.

### Supplementary Note 30

The information processing method according to supplementary note 29, further including:
in a case where the result of the authentication is the authentication success, outputting second information generated based on the first information to the first terminal.

### Supplementary Note 31

The information processing method according to supplementary note 30, in which
the first information is message information, and
the second information is processed information obtained by processing the message information.

### Supplementary Note 32

The information processing method according to supplementary note 31, further including:

outputting a transmission permission to a transmission source of the first information based on the result of the authentication; and
detecting the first information from the transmission source based on the transmission permission.

### Supplementary Note 33

The information processing method according to supplementary note 31 or 32, further including:
specifying reading content of the message information based on setting information stored in advance and outputting the second information including the reading content to the first terminal.

### Supplementary Note 34

The information processing method according to supplementary note 30, further including:
detecting first information transmitted from another device; and
outputting an information request according to the first information as the second information to the first terminal and outputting response information received from the first terminal based on the information request to the another device.

### Supplementary Note 35

The information processing method according to supplementary note 30, in which
the first information is sound, and
the information processing method further including:
outputting the second information generated based on the sound to the first terminal.

### Supplementary Note 36

An information processing method including:
being connected to each of a first terminal that has a structure for being worn on a user's ear and acquires a reflection signal of a signal output to inside of the ear and a second terminal that transmits information acquired from outside to a user in a state of being worn by the user;
acquiring a result of authentication performed using the reflection signal;
detecting acquisition of predetermined first information; and
outputting information regarding execution of predetermined processing executed using the first information to the second terminal, in a case where the result of the authentication is an authentication success.

### Supplementary Note 37

The information processing method according to supplementary note 36, further including:
in a case where the result of the authentication is the authentication success, outputting second information generated based on the first information to the second terminal.

### Supplementary Note 38

The information processing method according to supplementary note 37, in which
the first information is message information, and
the second information is processed information obtained by processing the message information.

### Supplementary Note 39

The information processing method according to supplementary note 38, further including:
outputting a transmission permission to a transmission source of the first information based on the result of the authentication; and
detecting the first information from the transmission source based on the transmission permission.

### Supplementary Note 40

The information processing method according to supplementary note 38 or 39, further including:
specifying reading content of the message information based on setting information stored in advance and outputting the second information including the reading content to the second terminal.

### Supplementary Note 41

The information processing method according to supplementary note 37, further including:
detecting first information transmitted from another device; and
outputting an information request according to the first information as the second information to the second terminal and outputting response information received from the second terminal based on the information request to the another device.

### Supplementary Note 42

The information processing method according to supplementary note 37, in which
the first information is sound, and
the information processing method further including:
outputting the second information generated based on the sound to the second terminal.

### Supplementary Note 43

A program for causing a computer of an information processing device to function as:
connection means for being connected to a first terminal that has a structure for being worn on a user's ear, acquires a reflection signal of a signal output to inside of the ear, and transmits information acquired from outside to a user in a state of being worn by the user;
authentication result acquisition means for acquiring a result of authentication performed using the reflection signal;
detection means for detecting acquisition of predetermined first information; and
execution means for outputting information regarding execution of predetermined processing executed using the first information to the first terminal, in a case where the result of the authentication is an authentication success.

### Supplementary Note 44

The program according to supplementary note 43, in which
in a case where the result of the authentication is the authentication success, the execution means outputs second information generated based on the first information to the first terminal.

### Supplementary Note 45

The program according to supplementary note 44, in which
the first information is message information, and
the second information is processed information obtained by processing the message information.

### Supplementary Note 46

The program according to supplementary note 45, further including:
permission means for outputting a transmission permission to a transmission source of the first information based on the result of the authentication, in which
the detection means detects the first information from the transmission source based on the transmission permission.

### Supplementary Note 47

The program according to supplementary note 45 or 46, in which
the execution means specifies reading content of the message information based on setting information stored in advance and outputs the second information including the reading content to the first terminal.

### Supplementary Note 48

The program according to supplementary note 44, in which
the detection means detects first information transmitted from another device, and
the execution means outputs an information request according to the first information as the second information to the first terminal and outputs response information received from the first terminal based on the information request to the another device.

### Supplementary Note 49

The program according to supplementary note 44, in which
the first information is sound, and
the execution means outputs the second information generated based on the sound to the first terminal.

### Supplementary Note 50

A program for causing a computer of an information processing device to function as:
connection means for being connected to each of a first terminal that has a structure for being worn on a user's ear and acquires a reflection signal of a signal output to inside of the ear and a second terminal that transmits information acquired from outside to a user in a state of being worn by the user;
authentication result acquisition means for acquiring a result of authentication performed using the reflection signal;
detection means for detecting acquisition of predetermined first information; and
execution means for outputting information regarding execution of predetermined processing executed using the first information to the second terminal, in a case where the result of the authentication is an authentication success.

### Supplementary Note 51

The program according to supplementary note 50, in which
in a case where the result of the authentication is the authentication success, the execution means outputs second information generated based on the first information to the second terminal.

### Supplementary Note 52

The program according to supplementary note 51, in which
the first information is message information, and
the second information is processed information obtained by processing the message information.

### Supplementary Note 53

The program according to supplementary note 52, further including:
permission means for outputting a transmission permission to a transmission source of the first information based on the result of the authentication, in which
the detection means detects the first information from the transmission source based on the transmission permission.

### Supplementary Note 54

The program according to supplementary note 52 or 53, in which
the execution means specifies reading content of the message information based on setting information stored in advance and outputs the second information including the reading content to the second terminal.

### Supplementary Note 55

The program according to supplementary note 51, in which
the detection means detects first information transmitted from another device, and
the execution means outputs an information request according to the first information as the second information to the second terminal and outputs response information received from the second terminal based on the information request to the another device.

### Supplementary Note 56

The program according to supplementary note 51, in which
the first information is sound, and
the execution means outputs the second information generated based on the sound to the second terminal.

### Supplementary Note 57

An information processing device including:
connection means for being connected to a first terminal that acquires biometric information of a user and transmits information acquired from outside to the user in a state of being worn by the user;
authentication result acquisition means for acquiring a result of authentication performed using the biometric information;
detection means for detecting acquisition of predetermined first information; and
execution means for outputting information regarding execution of predetermined processing executed using the first information to the first terminal, in a case where the result of the authentication is an authentication success.

### Supplementary Note 58

The information processing device according to supplementary note 57, in which
in a case where the result of the authentication is the authentication success, the execution means outputs second information generated based on the first information to the first terminal.

### Supplementary Note 59

The information processing device according to supplementary note 58, in which
the first information is message information, and
the second information is processed information obtained by processing the message information.

### Supplementary Note 60

The information processing device according to supplementary note 59, further including:
permission means for outputting a transmission permission to a transmission source of the first information based on the result of the authentication, in which
the detection means detects the first information from the transmission source based on the transmission permission.

### Supplementary Note 61

The information processing device according to supplementary note 59 or 60, in which
the execution means specifies reading content of the message information based on setting information stored in advance and outputs the second information including the reading content to the first terminal.

### Supplementary Note 62

The information processing device according to supplementary note 58, in which
the detection means detects first information transmitted from another device, and
the execution means outputs an information request according to the first information as the second information to the first terminal and outputs response information received from the first terminal based on the information request to the another device.

### Supplementary Note 63

The information processing device according to supplementary note 58, in which
the first information is sound, and
the execution means outputs the second information generated based on the sound to the first terminal.

### Supplementary Note 64

An information processing device including:
connection means for being connected to each of a first terminal that acquires biometric information of a user and a second terminal that transmits information acquired from outside to the user in a state of being worn by the user;
authentication result acquisition means for acquiring a result of authentication performed using the biometric information;
detection means for detecting acquisition of predetermined first information; and
execution means for outputting information regarding execution of predetermined processing executed using the first information to the second terminal, in a case where the result of the authentication is an authentication success.

### Supplementary Note 65

The information processing device according to supplementary note 64, in which
in a case where the result of the authentication is the authentication success, the execution means outputs second information generated based on the first information to the second terminal.

### Supplementary Note 66

The information processing device according to supplementary note 65, in which
the first information is message information, and
the second information is processed information obtained by processing the message information.

### Supplementary Note 67

The information processing device according to supplementary note 66, further including:
permission means for outputting a transmission permission to a transmission source of the first information based on the result of the authentication, in which
the detection means detects the first information from the transmission source based on the transmission permission.

### Supplementary Note 68

The information processing device according to supplementary note 66 or 67, in which
the execution means specifies reading content of the message information based on setting information stored in advance and outputs the second information including the reading content to the second terminal.

### Supplementary Note 69

The information processing device according to supplementary note 65, in which
the detection means detects first information transmitted from another device, and
the execution means outputs an information request according to the first information as the second information to the second terminal and outputs response information received from the second terminal based on the information request to the another device.

### Supplementary Note 70

The information processing device according to supplementary note 65, in which
the first information is sound, and
the execution means outputs the second information generated based on the sound to the second terminal.

### REFERENCE SIGNS LIST

1 portable terminal (information processing device)
2 earphone (first terminal)
4 head mount terminal
5 headphone
6 on-vehicle device
11 control unit
12 communication connection unit (connection means 151)
13 authentication unit
14 authentication result acquisition unit (authentication result acquisition means 152)
15 detection unit (detection means 153)
16 execution unit (execution means 154)
17 storage unit
21 control unit
22 communication unit
23 sound output unit
24 authentication processing unit
25 display
26 vibration unit
100 information processing system

What is claimed is:

1. An information processing device comprising:
a memory configured to store instruction; and
at least one processor configured to execute the instructions to perform:
connecting to a first terminal that has a structure for being worn on a user's ear, acquiring a reflection signal of a signal output to inside of the ear, and transmitting information acquired from outside to the user;
acquiring a result of authentication performed using the reflection signal;
detecting acquisition of predetermined first information; and
outputting information regarding execution of predetermined processing executed using the first information to the first terminal, in a case where the result of the authentication is an authentication success.

2. The information processing device according to claim 1, wherein
the at least one processor is configured to execute the instructions to perform:
in a case where the result of the authentication is the authentication success, outputting second information generated based on the first information to the first terminal.

3. The information processing device according to claim 2, wherein
the first information is message information, and
the second information is processed information obtained by processing the message information.

4. The information processing device according to claim 3, wherein
the at least one processor is further configured to execute the instructions to perform:
outputting a transmission permission to a transmission source of the first information based on the result of the authentication, wherein
the at least one processor is configured to execute the instructions to perform:
detecting the first information from the transmission source based on the transmission permission.

5. The information processing device according to claim 3, wherein
the at least one processor is configured to execute the instructions to perform:
specifying reading content of the message information based on setting information stored in advance and outputting the second information including the reading content to the first terminal.

6. The information processing device according to claim 2, wherein
the at least one processor is configured to execute the instructions to perform:
detecting first information transmitted from another device, and
outputting an information request according to the first information as the second information to the first terminal and outputting response information received from the first terminal based on the information request to the another device.

7. An information processing device comprising:
a memory configured to store instruction; and
at least one processor configured to execute the instructions to perform:
connecting to each of a first terminal that has a structure for being worn on a user's ear and acquiring a reflection signal of a signal output to inside of the ear and a second terminal that transmits information acquired from outside to the user;
acquiring a result of authentication performed using the reflection signal;
detecting acquisition of predetermined first information; and
outputting information regarding execution of predetermined processing executed using the first information to the second terminal, in a case where the result of the authentication is an authentication success.

8. An information processing method comprising:
connecting to a first terminal that has a structure for being worn on a user's ear acquiring a reflection signal of a signal output to inside of the ear, and transmitting information acquired from outside to the user;
acquiring a result of authentication performed using the reflection signal;
detecting acquisition of predetermined first information; and
outputting information regarding execution of predetermined processing executed using the first information to the first terminal, in a case where the result of the authentication is an authentication success.

9. A non-transitory storage medium storing a program for causing a computer of an information processing device to perform:
connecting to a first terminal that has a structure for being worn on a user's ear, acquiring a reflection signal of a signal output to inside of the ear, and transmitting information acquired from outside to the user;
acquiring a result of authentication performed using the reflection signal;
detecting acquisition of predetermined first information; and
outputting information regarding execution of predetermined processing executed using the first information to the first terminal, in a case where the result of the authentication is an authentication success.

10. An information processing device comprising:
a memory configured to store instruction; and
at least one processor configured to execute the instructions to perform:
connecting to a first terminal that acquires biometric information of a user and transmitting information acquired from outside to the user;
acquiring a result of authentication performed using the biometric information;
detecting acquisition of predetermined first information; and
outputting information regarding execution of predetermined processing executed using the first information to the first terminal, in a case where the result of the authentication is an authentication success.
